(19) United States
(12) Patent Application Publication
(10) Pub. No.: US 2007/0197730 A1
(43) Pub. Date: Aug. 23, 2007

(54) Hydrophilic polypropylene compositions and methods of forming the same

(75) Inventors: Fengkui Li, Houston, TX (US); John Bieser, Houston, TX (US); Likuo Sun, Houston, TX (US); Layne Lumus, Dickinson, TX (US)

Correspondence Address: David J. Alexander, P.O. Box 674412, Houston, TX, 77167, US

(73) Assignee: Fina Technology, Inc., Houston, TX (US)

(21) Appl. No.: 11/796,061

(22) Filed: Apr. 26, 2007

Related U.S. Application Data
(63) Continuation-in-part of application No. 10/996,744, filed on Nov. 24, 2004.
(60) Provisional application No. 60/525,173, filed on Nov. 26, 2003.

(51) Int. Cl. C08F 8/00

(52) U.S. Cl. 525/191

(57) ABSTRACT

Polyolefin blends and processes for forming polyolefin blends are described herein. The blends generally include a polyolefin and a monomer system including triacrylate monomers. The blends may further include one or more chain transfer agents.

### CROSS-REFERENCE TO RELATED APPLICATIONS

This application claims the benefit of U.S. patent application Ser. No. 10/996,744, filed Nov. 24, 2004, which claims the benefit of U.S. Provisional Patent Application Ser. No. 60/525,173, filed Nov. 26, 2003.

### FIELD

Embodiments of the present invention generally relate to hydrophilic polyolefin compositions, methods of forming the same and articles formed therefrom. In particular, embodiments of the invention generally relate to hydrophilic polypropylene compositions.

### BACKGROUND

As reflected in the patent literature, polyolefins have been widely used in a variety of applications due to their low cost and ease of manipulation. However, certain properties such as impact resistance, paintability, printability and dyeability expose deficiencies that may exist in some products manufactured from polyolefins.

For example, it is often desirable to be able to apply ink to a polyolefin film in a printing process (i.e., printability). Water based inking systems generally require a substrate surface tension of greater than about 36 dyne/cm² or greater than about 40 dyne/cm² to provide acceptable adhesion and wettability. However, conventional polyolefin films may display a surface tension that is less than the surface tension required for adequate printability.

Therefore, a need exists to develop polyolefins having enhanced surface tension and printability, along with other properties, such as impact resistance.

### SUMMARY

Embodiments of the present invention include polyolefin blends. The blends generally include a polyolefin and a monomer system including triacrylate monomers. In one or more embodiments, the blends include one or more chain transfer agents.

Embodiments of the invention further include processes to modify polyolefins. The processes generally include providing a polyolefin, providing a monomer system including a triacrylate monomer, providing a chain transfer agent and blending the monomer system with the polyolefin to form a modified polyolefin in the presence of a chain transfer agent.

In one embodiment, the blend includes a polyolefin and a monomer system comprising triacrylate monomers. In such an embodiment, the blend generally exhibits a surface tension of from about 40 dyne/cm² to about 60 dyne/cm².

### DETAILED DESCRIPTION

Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

Catalyst Systems

Catalyst systems useful for polymerizing olefin monomers include any catalyst system known to one skilled in the art for such a process. For example, the catalyst system may include metallocene catalyst systems, single site catalyst systems, Ziegler-Natta catalyst systems or combinations thereof, for example.

Polymerization Processes

As indicated elsewhere herein, catalyst systems are used to form polyolefin compositions. Once the catalyst system is prepared, a variety of processes may be carried out using that catalyst system. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. Other monomers include ethylenically unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 45 bar and a temperature of from about 38° C. to about 121° C., for example. Reaction heat may be removed through the loop wall via any method known to one skilled in the art, such as via a double-jacketed pipe.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

Polymer Product

The polymers (and blends thereof) formed via the processes described herein may include, but are not limited to, linear low density polyethylene, elastomers, plastomers, high density polyethylenes, low density polyethylenes, medium density polyethylenes, polypropylene (e.g., syndiotactic, atactic and isotactic) and polypropylene copolymers and combinations thereof, for example.

Embodiments of the invention generally include blending one or more of the polymers with a monomer system to form a modified polyolefin. In one embodiment, the monomer system is blended with the polymer in an amount to provide a modified polyolefin having from about 5 wt. % to about 45 wt. %, or from about 10 wt. % to about 40 wt. %, or from about 5 wt. % to about 25 wt. % or from about 10 wt. % to about 20 wt. % monomer system, for example.

The monomer system generally includes a first monomer. The first monomer generally includes tri-acrylate monomers, such as trimethylolpropane triacrylate, pentaerythritol triacrylate, glycerol triacrylate, polyoxypropyltrimethylolpropane triacrylate, polyoxyethyltrimethylolpropane triacrylate, pentaerythritol triacrylate or combinations thereof, for example. In one embodiment, the triacrylate monomer includes a trimethacrylate monomer, such as trimethylolpropane trimethacrylate, for example.

In addition, the monomer system may include any other monomer (e.g., second and third monomers) capable of resulting in a modified polyolefin having a discontinuous nanoparticulate dispersion. As used herein, the term “discontinuous nanoparticulate dispersion” refers to a monomer (e.g., dispersion or as discussed below, first monomer) disposed within a continuous polyolefin phase. When the monomer system includes monomers other than the tri-acrylates, the tri-acrylates generally comprise at least about 10 wt. %, or at least about 15 wt. %, or at least about 20 wt. %, or at least about 30 wt. % or at least about 50 wt. % of the monomer system, for example.

In one embodiment, the other monomers may include monofunctional monomers, difunctional monomers, hexafunctional monomers, tetrafunctional monomers, pentafunctional monomers and/or trifunctional monomers, such as those that are commercially available from Sartomer, Inc., Exton, Pa.

In one embodiment, the other monomer(s) may include acrylic monomers. The acrylic monomers may include 2-(2-ethoxyethoxy) ethyl acrylate, diethylene glycol diacrylate, tridecyl acrylate, tridecylacrylate hexanediol diacrylate, lauryl acrylate, alkoxylated lauryl acrylate, caprolactone acrylate, 1, 6-hexanediol diacrylate, polyethylene glycol diacrylate, neopentane diol diacrylate, polyethylene glycol diacrylate and combinations thereof, for example.

In addition to the acrylic monomer(s), the monomer system may further include another monomer. The other monomer may include ethylenically unsaturated monomers, such as styrene, for example. In one embodiment, the monomer system includes hydrophilic monomers. As used herein, the term “hydrophilic” refers to monomers having oxygen or nitrogen atoms in their backbone structure. The hydrophilic monomers may include 2-(2-ethoxyethoxy) ethyl acrylate, tetrahydrofufuryl acrylate, polyethylene glycol (200) diacrylate, tetraethylene glycol diacrylate, triethylene glycol diacrylate, tripropylene glycol diacrylate and polyethylene glycol (400) diacrylate, for example.

The average particle size of the dispersion may be from about 2 nm to about 1000 nm, or from about 2 nm to about 500 nm, or from about 2 nm to about 400 nm or from about 2 nm to about 300 nm, for example. The dispersion may have a particle size distribution wherein at least about 50%, or at least about 60%, or at least about 70%, or at least about 80% or at least about 90% of the particles have a maximum particle size of about 100 nm or about 50 nm, for example.

In one or more embodiments, the monomer system includes a concentrated monomer system. As used herein, the term “concentrated monomer system” refers to a system that includes the first monomer at a first concentration blended with a first portion of a polyolefin. The system is then blended with a second portion of the polyolefin, resulting in a modified polyolefin having a second concentration of acrylic monomer, the second concentration being lower than the first concentration.

For example, the monomer system may include from about 10 wt. % to about 90 wt. %, or from about 15 wt. % to about 85 wt. %, or from about 25 wt. % to about 85 wt. %, or from about 30 wt. % to about 80 wt. % or from about 35 wt. % to about 75 wt. % acrylic monomer, for example.

As used herein, the term “blending” generally refers to introducing the polyolefin and the monomer system into a system capable of forming a separate, dispersed nanoparticulate polymer phase in a continuous polyolefin phase. For example, the blending may be accomplished introducing the polyolefin and monomer system into a batch mixer, continuous mixer, single screw extruder or twin screw extruder, for example, to form a homogeneous mixture or solution, introducing a free radical catalyst and providing pressure and temperature conditions so as to polymerize the monomer system and form a separate, dispersed nanoparticulate polymer phase in a continuous polyolefin phase (modified polyolefin).

Embodiments of the invention may further include contacting the polyolefin and the monomer system with a chain transfer agent. Such contact may occur via any method known to one skilled in the art, such as blending. The chain transfer agent may include any agent known to one skilled in the art suitable for adjusting molecular weight. For example, the chain transfer agent may include a mercaptan, such as normal dedocyl mercaptan (NDM).

In one embodiment, the process includes contacting the polyolefin and monomer system with from about 15 ppm to about 5000 ppm, or from about 50 ppm to about 3000 ppm, or from about 75 ppm to about 1500 ppm or from about 100 ppm to about 1000 ppm chain transfer agent, for example.

The blending process may further include contacting the polyolefin, the monomer system or a combination thereof with an initiator. Such contact may occur as is known to one skilled in the art. The initiator may include any initiator known to one skilled in the art, such as a free radical initiator. The free radical initiator may include peroxides, such as Triganox 301 (commercially available from Akzo-Nobel Chemicals, Inc.) or Lupersol 101 (n-butylperoxy neodecanoate), for example.

Unexpectedly, the modified polyolefin flows as if it was a single phase polyolefin. Further, the modified polyolefin exhibits increased impact resistance without a large change in the polyolefin properties (e.g., the monomer system including tri-acrylates exhibits impact resistance that is from about 75% to about 125% greater than that of an unmodified polyolefin.) For example, the modified polyolefin may exhibit a surface tension of from about 40 dyne/cm² to about 60 dyne/cm², or from about 45 dyne/cm² to about 55 dyne/cm² or from about 48 dyne/cm² to about 52 dyne/cm², for example.

In addition, the modified polyolefin exhibited a further increase in impact resistance when contacted with a chain transfer agent (e.g., from about 50% to about 150%, or from about 60% to about 125% or from about 75% to about 100% greater than the modified polyolefin absent chain transfer agent, or in the alternative, from about 50% to about 250%, or from about 60% to about 125% or from about 75% to about 100% greater than the modified polyolefin absent the triacrylate in the monomer system). The modified polyolefin may further exhibit improved printability, paintability, dyeability and surface wettability, for example.

Product Application

The modified polyolefins formed herein are useful in applications known to one skilled in the art, such as forming operations (e.g., film, sheet, pipe and fiber extrusion and co-extrusion as well as blow molding, injection molding and rotary molding). Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include melt spinning, solution spinning and melt blown fiber operations for use in woven or non-woven form to make filters, diaper fabrics, medical garments and geotextiles, for example. Extruded articles include medical tubing, wire and cable coatings, geomembranes and pond liners, for example. Molded articles include single and multi-layered constructions in the form of bottles, tanks, large hollow articles, rigid food containers and toys, for example.

In particular, the modified polyolefins formed herein can be used to form a wide variety of materials and articles having improved impact resistance, paintability, printability, biodegradability, wettability, tensile strength, impact strength, modulus, vapor transmission, thermoform processability, compatibility with fillers, compatibility in polymer blends, fire resistance, abrasion resistance, transparency, conductivity and/or resistance to photodegredation as compared to polyolefins having a continuous polyolefin phase. Such materials may include injection molded articles and cast films, for example.

### EXAMPLES

In the examples that follow, samples of modified polyolefins were prepared and their resulting properties compared with an unmodified polyolefin and modified polyolefins prepared with monomer systems absent triacrylates.

As used herein, the “monomer system” includes multiple liquid acrylate monomers commercially available from Sartomer, Inc. Monomer System I (hydrophilic) includes 40 wt. % alkoxylated lauryl acrylate, 30 wt. % 2(2-ethoxyethoxy) ethylacrylate and 30 wt. % trimethylolpropane triacrylate. Monomer System II (hydrophobic) includes 50 wt. % tridecyl acrylate, 40 wt. % caprolactone acrylate and 10 wt. % polyethylene glycol diacrylate and is used as a comparative monomer system.

As used herein, the “chain transfer agent” is n-dedocyl mercaptan.

As used herein, the initiator is commercially available from Akzo-Nobel Chemicals, Inc. under the trade name Trigonox 301.

The base polymer is a metallocene random copolymer having a melt flow rate of 11 g/10 min.

All inventive samples were prepared by reactively extruding the base polymer with 15 wt. % of the monomer system in a Leistritz Micro-27 twin-screw extruder. The properties of the inventive samples at varying chain transfer agent (CTA) levels, along with comparative examples are shown in Table 1.

TABLE 1

| | | Base | | | | | | |
|---|---|---|---|---|---|---|---|---|
| | | Polymer | | | | | | |
| | | (comp) | Monomer System II | | | Monomer System I | | |
| CTA (ppm) | | N/A | 0 | 300 | 1000 | 0 | 300 | 1000 |
| Tensile | Modulus (kpsi) | 107 | 77 | 75 | 75 | 82 | 82 | 82 |
| | Yield Strength | 2830 | 2220 | 2200 | 2200 | 2210 | 2210 | 2220 |
| | (kpsi) ASTM- | | | | | | | |
| | Break Strength | 2810 | 2400 | 2400 | 2400 | 2440 | 2460 | 2470 |
| | (kpsi) | | | | | | | |
| | Elongation@yield | 8.7 | 12.0 | 12.3 | 12.5 | 10.7 | 10.8 | 11.0 |
| | (%) | | | | | | | |
| | Elongation@break | No | No | No | No | No | No | No |
| | (%) | Break | Break | Break | Break | Break | Break | Break |
| Izod | Notched Izod@ | 1.0 | 1.2 | 1.2 | 1.2 | 2.1 | 2.8 | 3.0 |
| | complete break | | | | | | | |
| | (ft-lb/in) | | | | | | | |
| Surface | Surface Tension | 36 | 40 | 40 | 40 | 50 | 50 | 50 |
| | (dyne/cm) | | | | | | | |

Unexpectedly, the embodiments described herein result in a modified polyolefin having a notched Izod impact resistance that can be increased by about 100% over modified polyolefins formed with monomer systems absent triacrylates. Further, it was observed that the use of NDM (1000 ppm) as the chain transfer agent does not significantly alter the tensile mechanical properties, while further increasing the impact resistance by an additional 100%.

While the foregoing is directed to embodiments of the present invention, other and further embodiments of the invention may be devised without departing from the basic scope thereof and the scope thereof is determined by the claims that follow.

What is claimed is:

1. A polyolefin blend comprising:
a polyolefin;
a monomer system comprising triacrylate monomers; and
a chain transfer agent.

2. The blend of claim 1, wherein the polyolefin comprises polypropylene.

3. The blend of claim 1 further comprising from about 5 wt. % to about 40 wt. % of the monomer system.

4. The blend of claim 1, wherein the triacrylate monomer comprises trimethylpropane triacrylate.

5. The blend of claim 1, wherein the monomer system comprises at least about 30 wt. % triacrylates.

6. The blend of claim 1, wherein the chain transfer agent comprises a mercaptan.

7. The blend of claim 1, wherein the blend is capable of forming a polymer article having an impact resistance that is greater than a polymer article formed from a monomer system absent a triacrylate.

8. The blend of claim 1, wherein the blend is capable of forming a polymer article having an impact resistance that is greater than a polymer article absent a chain transfer agent.

9. The blend of claim 1 formed by a process comprising:
providing the polyolefin;
providing the monomer system;
blending the polyolefin and monomer system in the presence of the chain transfer agent to form the blend.

10. A process of modifying polyolefins comprising:
providing a polyolefin;
providing a monomer system comprising a triacrylate monomer;
providing a chain transfer agent; and
blending the monomer system with the polyolefin in the presence of a chain transfer agent to form a modified polyolefin.

11. The process of claim 10, wherein the polyolefin comprises polypropylene.

12. The process of claim 10, wherein the triacrylate monomer comprises trimethylolpropane triacrylate.

13. The process of claim 10, wherein the monomer system further comprises another monomer selected from 2-(2-ethoxyethoxy) ethyl acrylate, diethylene glycol diacrylate, tridecyl acrylate, tridecylacrylate hexanediol diacrylate, lauryl acrylate, alkoxylated lauryl acrylate, caprolactone acrylate, 1, 6-hexanediol diacrylate, trimethylolpropane triacrylate, polyethylene glycol diacrylate, neopentane diol diacrylate, polyethylene glycol diacrylate and combinations thereof.

14. The process of claim 13, wherein the monomer system comprises at least about 30 wt. % triacrylate monomer.

15. The process of claim 10, wherein the chain transfer agent comprises a mercaptan.

16. The process of claim 10, wherein from about 50 ppm to about 5000 ppm of the chain transfer agent contacts the monomer system, the polyolefin or combinations thereof.

17. The process of claim 10, wherein the modified polyolefin comprises from about 5 wt. % to about 40 wt. % monomer system.

18. A polymer article formed from the modified polyolefin of claim 10.

19. The polymer article of claim 18 exhibiting a surface tension of from about 35 dyne/cm² to about 70 dyne/cm².

20. The polymer article of claim 18 exhibiting a surface tension that is greater than a surface tension of an article formed with a monomer system absent chain transfer agent.

21. The polymer article of claim 18 exhibiting a surface tension that is from about 50% to about 150% greater than a surface tension of an article formed with a monomer system absent triacrylate monomers.

22. A polyolefin blend comprising:
a polyolefin; and
a monomer system comprising triacrylate monomers.

23. The blend of claim 22 further exhibiting a surface tension of from about 40 dyne/cm² to about 60 dyne/cm².

24. The blend of claim 22 further exhibiting a surface tension that is greater than a surface tension of a blend formed with a monomer system absent triacrylate monomers.
